(19) United States
(12) Patent Application Publication
(10) Pub. No.: US 2012/0236454 A1
(43) Pub. Date: Sep. 20, 2012

(54) OVERCURRENT PROTECTION CIRCUIT AND MOTHERBOARD HAVING SAME

(75) Inventors: HO-FENG LIN, Tu-Cheng (TW); CHIH-JEN TSAI, Tu-Cheng (TW)

(73) Assignee: HON HAI PRECISION INDUSTRY CO., LTD., Tu-Cheng (TW)

(21) Appl. No.: 13/094,772

(22) Filed: Apr. 26, 2011

(30) Foreign Application Priority Data
Mar. 18, 2011 (TW) 100109268

(51) Int. Cl. H02H 3/08

(52) U.S. Cl. 361/87

(57) ABSTRACT

An overcurrent protection circuit includes an input terminal, an output terminal, a first resistor, a second resistor, a current source and a comparator. The first resistor, the second resistor and the current source are connected in series in that order between the input terminal and ground. A first input pin of the comparator is connected to a first node between the second resistor and the current source. A second input pin of the comparator is connected to the input terminal An output pin of the comparator is connected to the output terminal. When current input through the input terminal is greater than a predetermined value, the overcurrent protection circuit outputs a signal indicative of the current being greater than the predetermined value through the output terminal.

### BACKGROUND

1. Technical Field

The present disclosure relates to overcurrent protection circuits and motherboards having the same.

2. Description of Related Art

In a computer system, such as a server system, a power supply unit powers a motherboard and related electronic components, such as central processing unit, on the motherboard. Current of any of output pins of the power supply unit is desirably smaller than a predetermined value to ensure normal operation of the computer system. If the current is greater than the predetermined value for more than one minute, it is dangerous for users and the computer system.

Therefore, an overcurrent protection circuit and a motherboard having the same which can overcome the limitations described, are needed.

### BRIEF DESCRIPTION OF THE DRAWINGS

FIG. 1 is a circuit diagram of a motherboard, according to a first embodiment.

FIG. 2 is a circuit diagram of a motherboard, according to a second embodiment.

FIG. 3 is a circuit diagram of a motherboard, according to a third embodiment.

FIG. 4 is a circuit diagram of a motherboard, according to a fourth embodiment.

### DETAILED DESCRIPTION

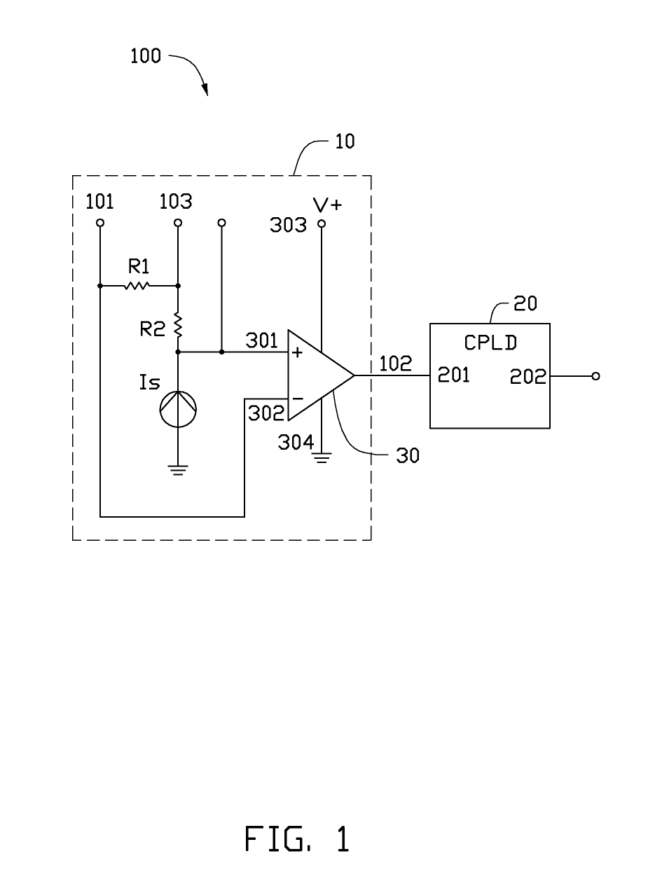

Referring to FIG. 1, a motherboard 100, according to a first embodiment, includes an overcurrent protection circuit 10 and a complex programmable logic device 20 connected to the circuit 10.

The circuit 10 includes an input terminal 101, an output terminal 102, a first resistor R1, a second resistor R2, a current source Is, a comparator 30, and a reference voltage terminal 103.

The first resistor R1, the second resistor R2 and the current source Is are connected in series in that order between the input terminal 101 and ground. The reference voltage terminal 103 is connected to a node between the first resistor R1 and the second resistor R2. The reference voltage terminal 103 may be connected to a positive power supply.

A first input pin 301 of the comparator 30 is connected to a node between the second resistor R2 and the current source Is. A second input pin 302 is connected to the input terminal 101. In this embodiment, the first input pin 301 is the non-inverting input pin of the comparator 30 and the second input pin 302 is the inverting input pin of the comparator 30. An output pin 102 of the comparator 30 serves as/is connected to the output terminal 102. A first power supply terminal 303 of the comparator 30 is configured to connecting to a positive power supply V+. A second power supply terminal 304 of the comparator 30 is grounded.

In this embodiment, a resistance value of the first resistor R1 is equal to that of the second resistor R2. If current I₁ input via the input terminal 101 is greater than a predetermined value, the circuit 10 is configured to output a signal indicative of the current I₁ being greater than the predetermined value.

In one embodiment, a voltage V302 of the second input pin 302 can be found using the formula: V₃₀₂=V₁₀₃+(I₁×R₁), and a voltage V301 of the first input pin 301 can be found using the formula: V₃₀₁=V₁₀₃+(I₂×R₂), where V₁₀₃ represents a voltage input via the reference voltage terminal 103, I₁ represents monitored current input via the input terminal 101 (the current flowing through the first resistor R1), I₂ represents current provided by the current source Is (the current flowing through the second resistor R2), R₁ represents a resistor value of the first resistor R1 and R₂ represents a resistor value of the second resistor R2. If the current I₁ is greater than the predetermined value, then V₃₀₂>V₃₀₁. The comparator 30 outputs a low-level (logic 0) signal indicative of the current I₁ being greater than the predetermined value via the output pin 102 to the complex programmable logic device 20. If the current I₁ is smaller than the predetermined value, then V₃₀₂<V₃₀₁. The comparator 30 outputs a high-level (logic 1) signal via the output pin 102 to the complex programmable logic device 20. R₁, R₂, and I₂ can be adjusted to monitor various I₁.

An input pin 201 of the complex programmable logic device 20 is connected to the output pin 102 of the comparator 30. When receiving the signal indicative of the current I₁ being greater than the predetermined value, the complex programmable logic device 20 shuts down predetermined enable signal(s) of providing voltage to electronic component(s), such as a central processing unit. Thus, the electronic component(s) can be shut down to protect users and the computer system.

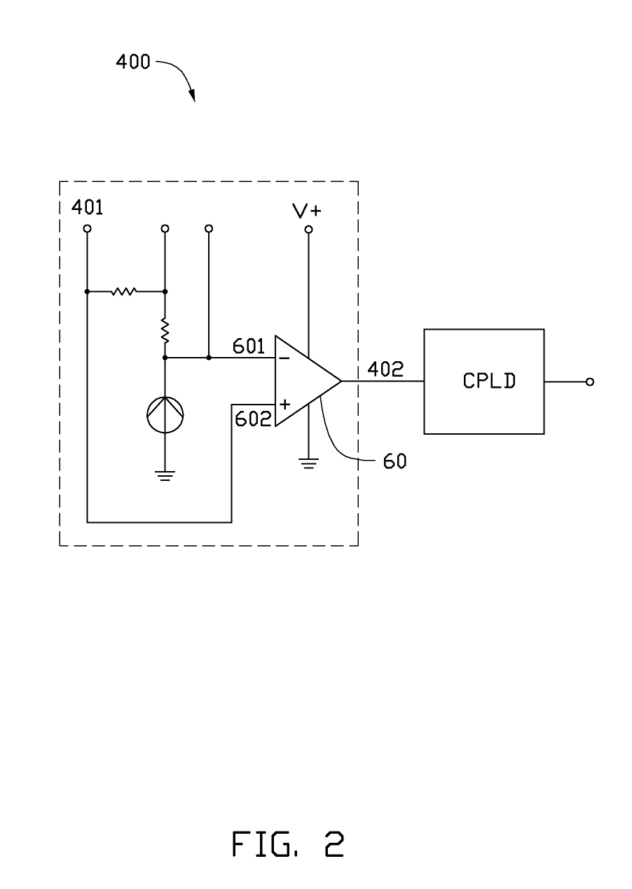

Referring to FIG. 2, a motherboard 400, according to a second embodiment, is shown. The differences between the motherboard 400 and the motherboard 100 of the first embodiment are that a first input pin 601 of a comparator 60 is the inverting input pin of the comparator 60 and a second input pin 602 of the comparator 60 is the non-inverting input pin of the comparator 60.

If the current I₁ is greater than the predetermined value, the comparator 60 outputs a high-level (logic 1) signal indicative of the current I₁ being greater than the predetermined value via an output pin 402 of the comparator 60. If the current I₁ is smaller than the predetermined value, the comparator 60 outputs a low-level (logic 0) signal via the output pin 402.

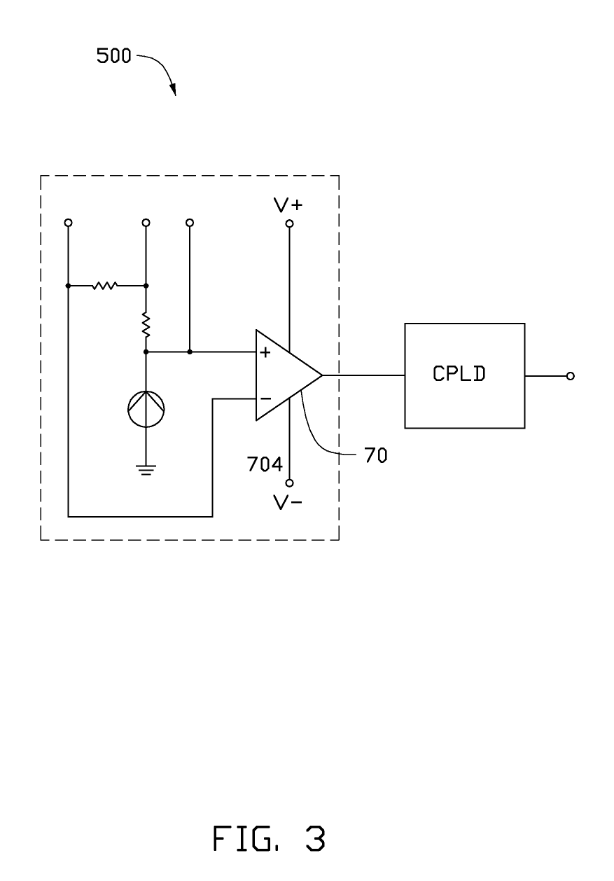

Referring to FIG. 3, a motherboard 500, according to a third embodiment, is shown. The difference between the motherboard 500 and the motherboard 100 of the first embodiment is that a second power supply terminal 704 of a comparator 70 is connected to a negative power supply V−.

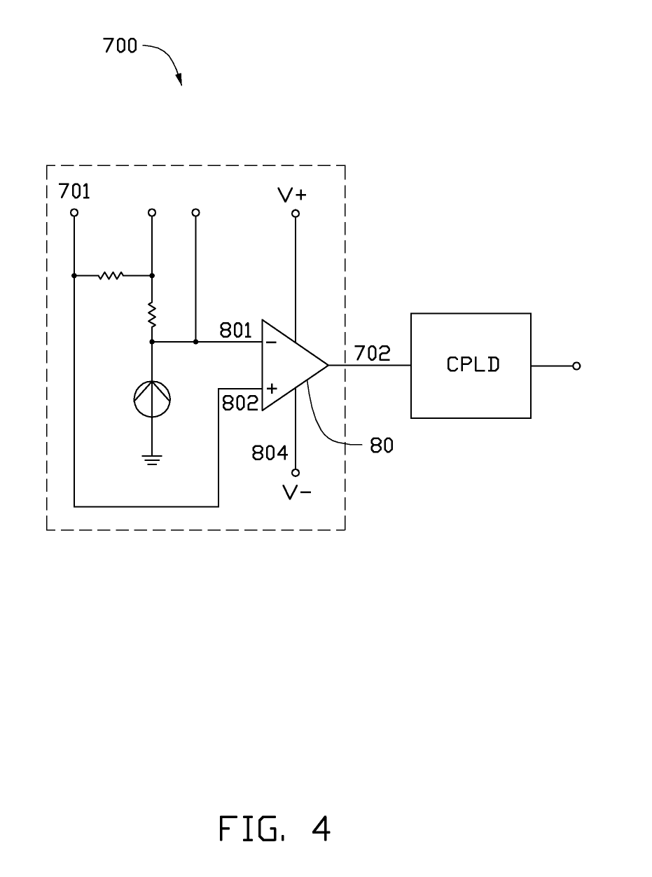

Referring to FIG. 4, a motherboard 700, according to a fourth embodiment, is shown. The differences between the motherboard 700 and the motherboard 100 of the first embodiment are that a second power supply terminal 804 of a comparator 80 is connected to a negative power supply V−, a first input pin 801 of the comparator 80 is the inverting input pin of the comparator 80 and a second input pin 802 of the comparator 80 is the non-inverting input pin of the comparator 80.

If the current I₁ is greater than the predetermined value, the comparator 80 outputs a high-level signal indicative of the current I₁ being greater than the predetermined value via an output pin 702 of the comparator 80. If the current I₁ is smaller than the predetermined value, the comparator 80 outputs a low-level signal via the output pin 702.

Advantages of the motherboards 400, 500, 700 of the second to fourth embodiments are similar to those of the motherboard 100 of the first embodiment.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An overcurrent protection circuit, comprising:
an input terminal;
an output terminal;
a first resistor;
a second resistor;
a current source; and
a comparator;
the first resistor, the second resistor and the current source connected in series in that order between the input terminal and ground, a first input pin of the comparator connected to a first node between the second resistor and the current source, a second input pin of the comparator connected to the input terminal, an output pin of the comparator connected to the output terminal, when current input through the input terminal is greater than a predetermined value, the overcurrent protection circuit outputs a signal indicative of the current being greater than the predetermined value through the output terminal.

2. The overcurrent protection circuit of claim 1, further comprising a reference voltage terminal connected between a second node between the first resistor and the second resistor.

3. The overcurrent protection circuit of claim 1, wherein the first input pin is the non-inverting input pin of the comparator and the second input pin is the inverting input pin of the comparator.

4. The overcurrent protection circuit of claim 3, wherein the signal indicative of the current being greater than the predetermined value is a low-level signal.

5. The overcurrent protection circuit of claim 4, wherein a signal indicative of the current being smaller than the predetermined value is a high-level signal.

6. The overcurrent protection circuit of claim 1, wherein the first input pin is the inverting input pin of the comparator and the second input pin is the non-inverting input pin of the comparator.

7. The overcurrent protection circuit of claim 6, wherein the signal indicative of the current being greater than the predetermined value is a high-level signal.

8. The overcurrent protection circuit of claim 7, wherein a signal indicative of the current being smaller than the predetermined value is a low-level signal.

9. The overcurrent protection circuit of claim 1, wherein the comparator comprises a first power supply terminal and a second power supply terminal, the first power supply terminal configured to connect to a positive power supply and the second power supply terminal configured to be grounded.

10. The overcurrent protection circuit of claim 1, wherein the comparator comprises a first power supply terminal and a second power supply terminal, the first power supply terminal configured to connect to a positive power supply and the second power supply terminal configured to connect to a negative power supply.

11. A motherboard, comprising an overcurrent protection circuit and a complex programmable logic device connected to the overcurrent protection circuit, the overcurrent protection circuit comprising an input terminal, an output terminal, a first resistor, a second resistor, a current source and a comparator, the first resistor, the second resistor and the current source connected in series in that order between the input terminal and ground, a first input pin of the comparator connected to a first node between the second resistor and the current source, a second input pin of the comparator connected to the input terminal, an output pin of the comparator connected to the output terminal, when current input through the input terminal is greater than a predetermined value, the overcurrent protection circuit outputs a signal indicative of the current being greater than the predetermined value through the output terminal, the complex programmable logic device configured to shut down an enable signal of providing voltage to an electronic component according to the signal indicative of the current being greater than the predetermined value.

12. The motherboard of claim 11, further comprising a reference voltage terminal connected between a second node between the first resistor and the second resistor.

13. The motherboard of claim 11, wherein the first input pin is the non-inverting input pin of the comparator and the second input pin is the inverting input pin of the comparator.

14. The motherboard of claim 13, wherein the signal indicative of the current being greater than the predetermined value is a low-level signal.

15. The motherboard of claim 14, wherein a signal indicative of the current being smaller than the predetermined value is a high-level signal.

16. The motherboard of claim 11, wherein the first input pin is the inverting input pin of the comparator and the second input pin is the non-inverting input pin of the comparator.

17. The motherboard of claim 16, wherein the signal indicative of the current being greater than the predetermined value is a high-level signal.

18. The motherboard of claim 17, wherein a signal indicative of the current being smaller than the predetermined value is a low-level signal.

19. The motherboard of claim 11, wherein the comparator comprises a first power supply terminal and a second power supply terminal, the first power supply terminal configured to connect to a positive power supply and the second power supply terminal configured to be grounded.

20. The motherboard of claim 11, wherein the comparator comprises a first power supply terminal and a second power supply terminal, the first power supply terminal configured to connect to a positive power supply and the second power supply terminal configured to connect to a negative power supply.
